(19) United States
(12) Patent Application Publication
(10) Pub. No.: US 2024/0196320 A1
(43) Pub. Date: Jun. 13, 2024

(54) COMMUNICATION TERMINAL, SIGNAL CONTROL APPARATUS, CONTROL METHOD FOR COMMUNICATION TERMINAL, AND PROGRAM RECORDING MEDIUM

(71) Applicant: NEC Corporation, Minato-ku, Tokyo (JP)

(72) Inventors: Kazuki OGATA, Tokyo (JP); Hiroaki AMINAKA, Tokyo (JP); Kosel KOBAYASHI, Tokyo (JP); Kei YANAGISAWA, Tokyo (JP); Jun TAKASAWA, Tokyo (JP)

(73) Assignee: NEC Corporation, Minato-ku, Tokyo (JP)

(21) Appl. No.: 18/284,632

(22) PCT Filed: Mar. 29, 2021
(86) PCT No.: PCT/JP2021/013408

§ 371 Date: Sep. 28, 2023

(51) Int. Cl. H04W 48/20; G08G 1/065; H04W 4/44

(52) U.S. Cl. CPC H04W 48/20; G08G 1/065; H04W 4/44

(57) ABSTRACT

A communication terminal includes a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road; a traffic flow detection part for detecting a traffic flow on at least one of the first road and the second road; and a selection part for selecting an antenna to be connected from the first antenna and the second antenna depending on the traffic flow.

This application is a National Stage Entry of PCT/JP2021/013408 filed on Mar. 29, 2021, the contents of all of which are incorporated herein by reference, in their entirety.

### FIELD

The present invention relates to a communication terminal, a signal control apparatus, a control method for a communication terminal, and a program recording medium.

### BACKGROUND

An installation of a base station for 5th generation mobile communication system (hereinafter referred to as “5G base station”) at traffic signal device (“traffic signals”) is being considered. In Non-Patent Literature (NPL) 1, it is presumed that the antenna is installed at the upper section of a signal pole (refer to Slide 7 “2. Network Architectures for Incorporating the 5G Technology into Traffic Signals”). It is also noted that when a directional antenna is used as the above antenna, three antennas are needed to emit radio waves over 360 degrees. In the NPL 1, it is also described that a 5G terminal is used for traffic control by connecting the 5G terminal to a signal control apparatus that controls a traffic signal to communicate with a traffic control system via the 5G base station above.

Patent Literature (PTL) 1 discloses a disaster prevention type signal control radio system installed at a traffic signal. In the PTL 1, it is described that a signal control radio master station is attached at a relatively high position, such as on top of a building or an antenna tower, and a signal control radio slave station is attached at a signal pole (see FIG. 1).
Japanese Patent Kokai Publication No. JP-P2014-52768A

The Ministry of Internal Affairs and Communications, Japan, “5th Generation Mobile Communication System Utilizing Traffic Signals: Investigation/Examination for Network Development: Report (FY2019): Summary,” [online], [searched on Mar. 19, 2021], the Internet <URL:

https://www.kantei.go.jp/jp/singi/it2/5g_tRUsstednet/dai2/siryou2-1.pdf>

### SUMMARY

The following analysis is given by the present inventors. A signal control apparatus is often installed near ground level in the vicinity of an intersection for ease of maintenance and other reasons. As shown in NPL 1, a 5G base station is being considered for installation on a signal pole. At some intersections, there is a case that a 5G terminal connected to the signal control apparatus may connect to an antenna installed on a signal pole at a location across a road. However, when a communication terminal connects to a base station on a signal pole located across the road, the communication between the communication terminal and the base station is affected by passing vehicles and other factors. The above problem can occur not only when it is installed at the base station, but also when it is installed on a pole near a traffic signal.

It is an object of the present invention to provide a communication terminal, a signal control apparatus, a control method for a communication terminal, and a program recording medium that can contribute to stabilizing the communication quality of a communication terminal that communicates with a base station installed on a signal pole or near a traffic signal.

According to a first aspect, there is provided a communication terminal, including:
a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road:
a traffic flow detection part for detecting a traffic flow on at least one of the first road and the second road; and
a selection part for selecting an antenna to be connected from the first antenna and the second antenna depending on the traffic flow.

According to a second aspect, there is provided a signal control apparatus including:
a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road:
a traffic flow detection part for detecting a traffic flow on at least one of the first road and the second road:
a selection part for selecting an antenna to be connected from the first antenna and the second antenna depending on the traffic flow: and a signal control part for controlling a traffic signal on a basis of control information received from a certain traffic control system via the communication part.

According to a third aspect, there is provided a control method for a communication terminal comprising a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road, the control method comprising:
detecting a traffic flow on at least one of the first road and the second road: and
selecting an antenna to be connected from the first antenna and the second antenna depending on the traffic flow.

The present method is associated with a certain machine referred to as the communication terminal provided with a communication part capable of communicating with two or more antennas using wireless (or radio).

According to a fourth aspect, there is provided a computer program (hereinafter referred to as “program”) for realizing the functions of the communication terminal or the signal control apparatus above. This program is supplied to a computer apparatus using an input device or from an outside via a communication interface, is stored in a storage device, and operates a processor according to predetermined steps or processes. In addition, this program can display processing results thereof including an intermediate state as necessary via a display device step by step or can communicate with the outside via the communication interface. For example, the computer apparatus for this purpose is typically provided with a processor, a storage device, an input device, a communication interface and a display device as needed, which can be connected to each other via a bus. In addition, this program can be recorded in a computer-readable (non-transitory) storage medium. In other words, the present invention can be implemented as a computer program product.

According to the present invention, it is possible to stabilize the communication quality of a communication terminal that communicates with a base station installed on a signal pole or near a traffic signal.

### BRIEF DESCRIPTION OF DRAWINGS

FIG. 1 is a drawing illustrating a configuration of an example embodiment according to the present invention.

FIG. 2 is a drawing illustrating a system configuration according to a first example embodiment of the present invention.

FIG. 3 is a diagram for describing an arrangement of antennas and a communication terminal according to the first example embodiment of the present invention.

FIG. 4 is a function block diagram showing a configuration of the communication terminal according to the first example embodiment of the present invention.

FIG. 5 is a flowchart showing an operation of the communication terminal according to the first example embodiment of the present invention.

FIG. 6 is a function block diagram showing a configuration of a communication terminal according to a second example embodiment of the present invention.

FIG. 7 is a drawing for describing an example of statistical information recorded in the communication terminal according to the second example embodiment of the present invention.

FIG. 8 is a drawing for explaining an operation according to the second example embodiment of the present invention.

FIG. 9 is a flowchart showing the operation of the communication terminal according to the second example embodiment of the present invention.

FIG. 10 is a drawing for describing a modified operation according to the second example embodiment of the present invention.

FIG. 11 is a function block diagram showing a configuration of a signal control apparatus according to a third example embodiment of the present invention.

FIG. 12 is a drawing illustrating a configuration of a computer that can function as a communication terminal or a signal control apparatus according to the present invention.

### EXAMPLE EMBODIMENTS

First, an outline of an example embodiment of the present invention will be given with reference to the drawings. It should be noted that the drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows the main flow of a signal (data) and does not exclude bidirectionality. Although the input/output connection points of each block in the drawings have ports or interfaces, these are not illustrated. A program is executed by a computer apparatus, and the computer apparatus is provided with, for instance, a processor, storage device, input device, communication interface, and a display device as necessary. Further, the computer apparatus is configured to be able to perform wired or wireless communication with an internal device therein or with an external device (including a computer) via the communication interface.

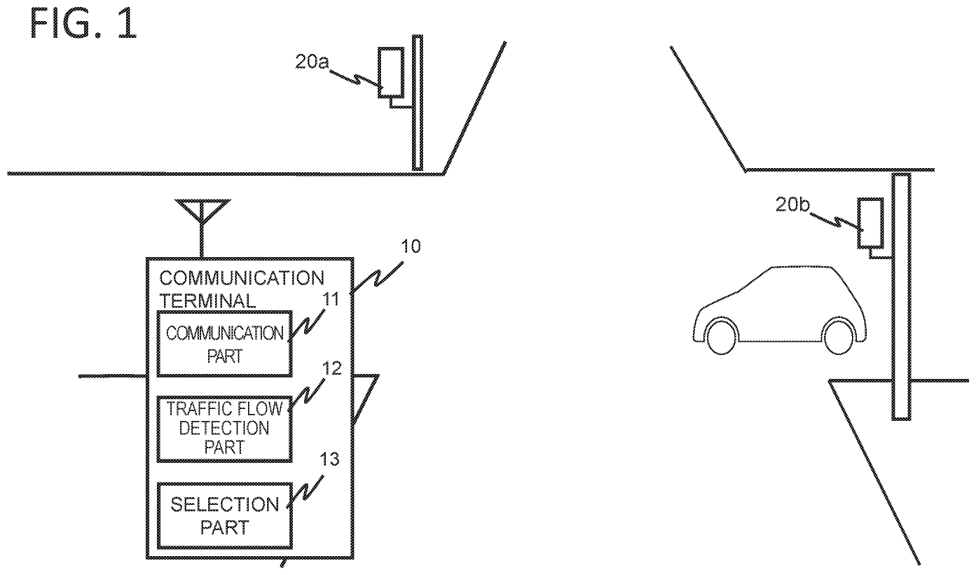

In an example embodiment, as shown in FIG. 1, the present invention can be realized by a communication terminal 10 that is provided with a communication part 11, a traffic flow detection part 12, and a selection part 13.

More concretely, the communication part 11 is configured to be able to select one of a first antenna 20a and a second antenna 20b to communicate with a base station connected to the first antenna and the second antenna. The first antenna 20a is installed at a first location opposing across a first road and the second antenna 20b is installed at a second location opposing across a second road intersecting the first road.

The traffic flow detection part 12 detects a traffic flow of at least one of the first road and the second road. Then, the selection part 13 selects an antenna to be connected from the first antenna 20a and the second antenna 20b, depending on the traffic flow detected. A possible method of selecting antennas according to the traffic flow is to select an antenna with a lower traffic flow on the road, i.e. an antenna with a lower number of obstructions moving between the antenna 20a or 20b and the communication terminal 10. A possible method of detecting the lower traffic flow on the road is to detect the traffic flows on both the first and second roads and compare each other. The method of detecting the traffic flow on at least one of the first road and the second road and selecting the antenna installed at a location across the road if the traffic flow is low, and selecting the other antenna if the traffic flow is high, can also be adopted.

According to the present example embodiment that operates as described above, it becomes possible to reduce the effects of vehicles passing on the road, etc., and to stabilize a communication quality of the communication terminal communicating with the base station installed on a signal pole.

### First Example Embodiment

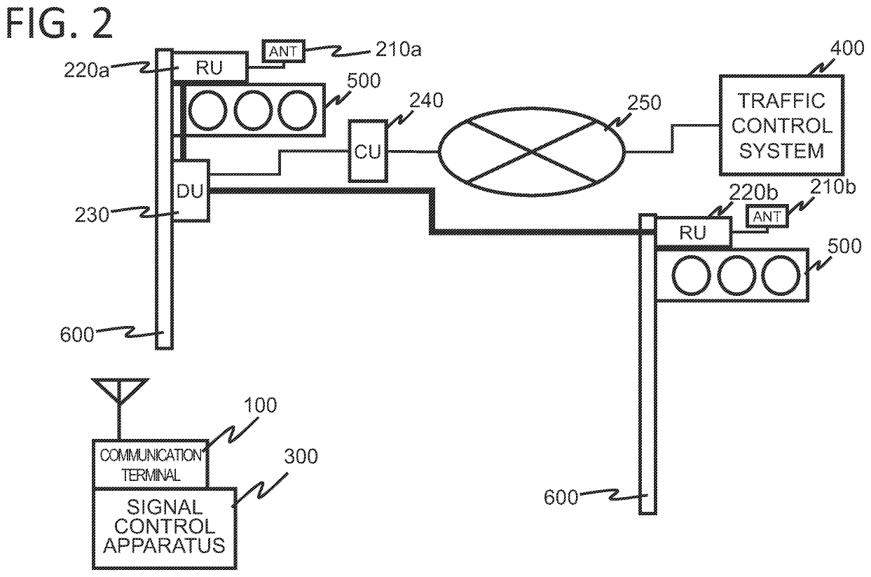

Next, a first example embodiment of the present invention, in which the present invention is applied to a communication terminal communicating with a 5G base station installed on a signal pole, will be described in detail with reference to drawings. FIG. 2 is a drawing illustrating a system configuration according to the first example embodiment of the present invention. With reference to FIG. 2, a configuration in which a 5G base station is installed on a signal pole 600, and a traffic control system 400 and a signal control apparatus 300 can be connected via a 5G core network 250 is shown.

In the example shown in FIG. 2, the 5G base station is configured to include a CU (Central Unit) 240, a Distributed Unit (DU) 230, Radio Units (RUs) 220a and 220b, and antennas (ANTs) 210a and 210b. The CU 240 is installed between the core network 250 and at least one DU 230 and functions as a data processing part. The DU 230 is connected to the RUs 220a and 220b and is responsible for a radio signal processing. The CU 240 is installed on a roof of a building near an intersection, on a steel tower nearby, etc. In some cases, the DU 230 is installed alongside the CU 240, but in NPL 1, the DU 230 is considered to be installed in a middle or upper section of a signal pole 600. The reason for this is that the DU 230 is intended to be connected to RUs 220a and 220b by an optical fiber.

The RUs 220a and 220b are connected to the DU 230 via optical fibers indicated by bold lines in FIG. 2, convert between digital and analog signals, and transmit/receive signals to/from a communication terminal 100 via the antennas 210a and 210b. It is desirable to install the RUs 220a and 220b as close as possible to the antennas 210a and 210b in terms of connection to the antennas 210a and 210b. As shown in FIG. 2, the RUs 220a and 220b can be installed on upper sections of the signal poles 600, e.g. on top of a light 500 of the traffic signal. Those integrated with the antennas 210a and 210b can be used as the RUs 220a and 220b.

The antennas 210a and 210b are connected to the RUs 220a and 220b, respectively, and transmit/receive analog signals between the RUs 220a and 220b, and the communication terminal 100. As for the antennas 210a and 210b, directional antennas such as Massive MIMO (Multiple-Input and Multiple-Output) antennas can be used to achieve high speed and high capacity, which is one of the features of 5G. In FIG. 2, it is shown that one antenna is installed on one signal pole 600, but multiple antennas may be connected to one RU. For example, a configuration with three antennas, each of which can cover 120 degrees, to cover 360 degrees can be adopted, as shown in NPL 1. These antennas 210a and 210b are preferably installed in a position suitable for an over the horizon communication with the communication terminal 100. For example, the antennas 210a and 210b can be installed on upper sections of the signal poles 600, e.g. on top of a light 500 of the traffic signal, as shown in FIG. 2.

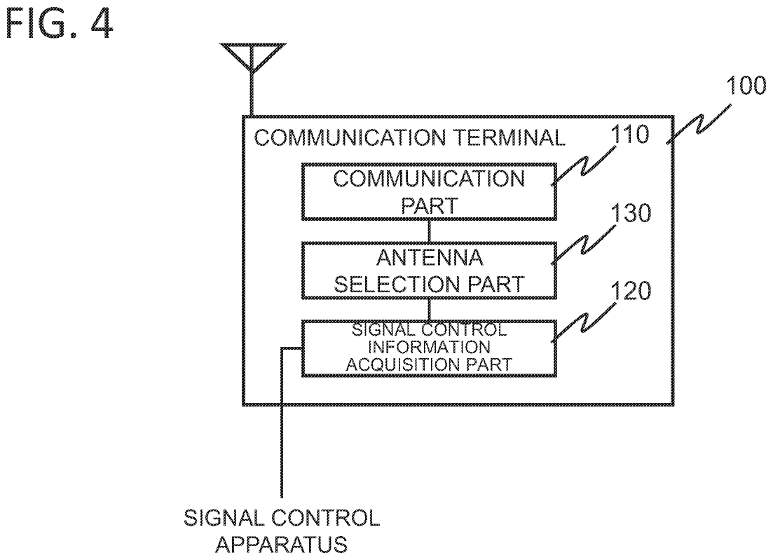

The communication terminal 100 is connected to the signal control apparatus 300 and connects to a 5G network via one of the RU 220a and the RU 220b. The communication terminal 100 provides a communication function to the signal control apparatus 300. The detail configuration of the communication terminal 100 will be described later with reference to FIG. 4.

The signal control apparatus 300 uses the communication terminal 100 to connect to the traffic control system 400 or a MEC (Multi-access Edge Computing) server under its control to perform communication for a traffic control. As for the communication for the traffic control, information received from the communication terminal 100, traffic volume and emergency vehicle passage information collected by other sensors, signal control based on a lighting state of a traffic signal of surrounding intersections, and so on are presumed.

The traffic control system 400 performs signal control on a basis of the information received from the communication terminal 100, the traffic volume and emergency vehicle passage information collected by other sensors, and the lighting state of the traffic signal of the surrounding intersections. Although omitted in FIG. 2, the traffic control system 400 may be provided with MEC servers under its control, and some of its functions may be carried out by these MEC servers.

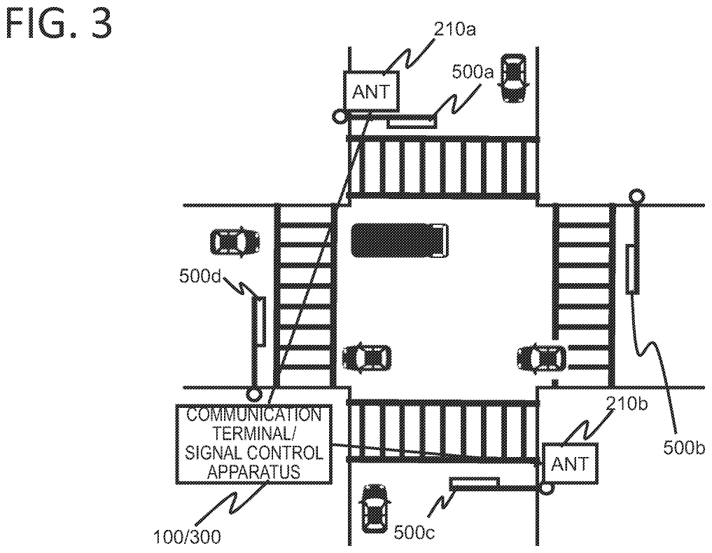

FIG. 3 is a diagram for describing an arrangement of antennas 210a and 210b and the communication terminal according to the first example embodiment of the present invention. In the following description, it is presumed that the communication terminal 100 is installed near the signal control apparatus 300 at the intersection and the antenna 210a is installed on a traffic signal 500a at a first location across a first road. Further, it is presumed that the antenna 210b is installed on a traffic signal 500c at a second location across a second road that intersects the first road. This arrangement allows the communication terminal 100 to select one of the antenna 210a and the antenna 210b to communicate with the RUs 220a and 220b, depending on the traffic flow. When there are third and fourth antennas and RUs, they may be installed on traffic signals 500b and 500d.

FIG. 4 is a function block diagram showing a configuration of the communication terminal 100 according to the first example embodiment of the present invention. With reference to FIG. 4, a configuration that is provided with a communication part 110, a signal control information acquisition part 120, and an antenna selection part 130 is shown.

The communication part 110 connects to the RUs 220a and 220b via the antennas 210a and 210b to perform communication. As for the communication part 110 itself, a terminal similar to a typical 5G terminal can be used.

The signal control information acquisition part 120 acquires signal control information from the signal control apparatus 300. As for the signal control information, a control parameter for controlling a lighting state of a light of a traffic signal at an intersection and information indicating a lighting state of a light of a traffic signal can be used. In the present example embodiment, the signal control information acquisition part 120 functions as a traffic flow detection means for detecting a traffic flow of a road using these signal control information. The signal control information is not limited to the examples above, a method can also be employed whereby the signal control information acquisition part 120 receives an explicit signal control instruction from the traffic control system 400 and information indicating the lighting state of the light of the traffic signal to detect a traffic flow on a road.

The antenna selection part 130 selects the antenna 210a or 210b, to which the communication terminal 100 is connected, depending on the traffic flow specified by the signal control information described above. The antenna selection function itself is also provided in a typical 5G terminal, so the antenna selection part 130 and the communication part 110 may be integrated.

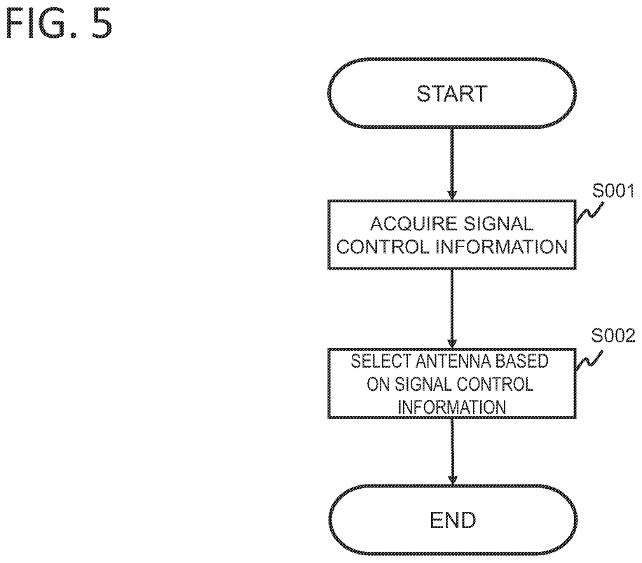

Next, an operation of the present example embodiment will be described in detail with reference to a drawing. FIG. 5 is a flowchart showing the operation of the communication terminal according to the first example embodiment of the present invention. With reference to FIG. 5, the communication terminal 100 acquires signal control information from the signal control apparatus 300 (step S001). In some traffic signals, the signal control information may remain unchanged for a certain period of time. In this case, the communication terminal 100 may omit the step S001.

The communication terminal 100 selects an antenna to be connected on the basis of the acquired signal control information (step S002).

At this time, the communication terminal 100 can reduce the effect caused by passing vehicles between the antennas 210a or 210b and the communication terminal 100 by selecting the antennas as follows.

First, virtual straight lines are drawn between the communication terminal 100 and the antennas 210a and 210b, as shown in FIG. 3. If there are no obstructions between these straight lines, the communication terminal 100 will be able to perform over the horizon communication with antennas 210a and 210b.

However, as shown in FIG. 3, when the lights of the traffic signals 500b and 500d are green, vehicles will pass on the road of which illustrated in the left-right direction in FIG. 3. Sometimes a large vehicle may pass on the road. If the antenna 210a is selected when the large vehicle is passing by, an obstruction will be placed between the communication terminal 100 and the antenna 210a, resulting in a momentary breakdown (very short communication breakdown) or interruption of communication.

This condition continues for a period of time that the lights of the traffic signals 500b and 500d are green, thereby, when the lights of the traffic signals 500b and 500d are green, the communication terminal 100 selects the antenna 210b. At least for the period of time that the lights of the traffic signals 500b and 500d are green, the lights of the traffic signals 500a and 500c will be non-green. For example, if the lights at the traffic signals 500a and 500c are red, the vehicle will stop before a stop line, so no vehicles will pass between the communication terminal 100 and the antenna 210b. It is also presumed that at some intersections, the lights at the traffic signals 500a and 500c may be flashing red lights, but even in this case, a volume of vehicle traffic will be limited and the communication between the communication terminal 100 and the antenna 210b is less likely to be affected.

Then, when the lights at the traffic signals 500a and 500c turn green, vehicles will pass on the road, which is illustrated in the vertical direction in FIG. 3. Therefore, the communication terminal 100 performs an operation to switch the connected antenna to the antenna 210a. For the period of time that the lights of the traffic signals 500a and 500c are green, the lights of the traffic signals 500b and 500d will be non-green. The communication terminal 100 can switch the antenna to be connected to the antenna 210a, thereby making the communication between the communication terminal 100 and the antenna 210b is less likely to be affected.

As described above, the communication terminal 100 selects the one of the antenna 210a and the antenna 210b whose straight line connecting the communication terminal 100 and the antenna 210a or the antenna 210b does not intersect with a lane in which a lighting state is green, and establishes the connection. This makes it possible to stabilize the communication between the communication terminal 100 and the 5G base station. There are no restrictions on a frequency band used between the RUs 220a and 220b and the communication terminal 100, specifically. However, it is presumed that the shorter the frequency band used, the greater the effect of the obstruction. For example, it is presumed that 5G will use a frequency band called Sub6 (5G NR FR1) and a frequency band called millimeter wave band (5G NR FR2), and the millimeter wave band is to be able to achieve a greater effect.

Due to performing the antenna switching described above, inter-base station handover occurs between the communication terminal 100 and the base stations (RUSs 220a and 220b). If necessary, it is preferable to perform the process of taking over a state of a session, etc., between a traffic control center and/or an MEC server under its control and the communication terminal 100, between RU220a and RU220b in advance.

As described above, according to the present example embodiment, it becomes possible to stabilize the quality of the communication between the traffic control center and/or an MEC server under its control and the signal control apparatus 300. The reason for this is that the communication terminal 100, which provides 5G connection function to the signal control apparatus 300, is configured to make antenna selection depending on a traffic flow.

### Second Example Embodiment

Next, a second example embodiment of the present invention, in which an antenna selection function based on statistical information is added to the communication terminal according to the first example embodiment, will be described in detail with reference to drawings. Since a configuration and an operation of the second example embodiment are almost the same as those of the first example embodiment, the second example embodiment will be described with a focus on the difference.

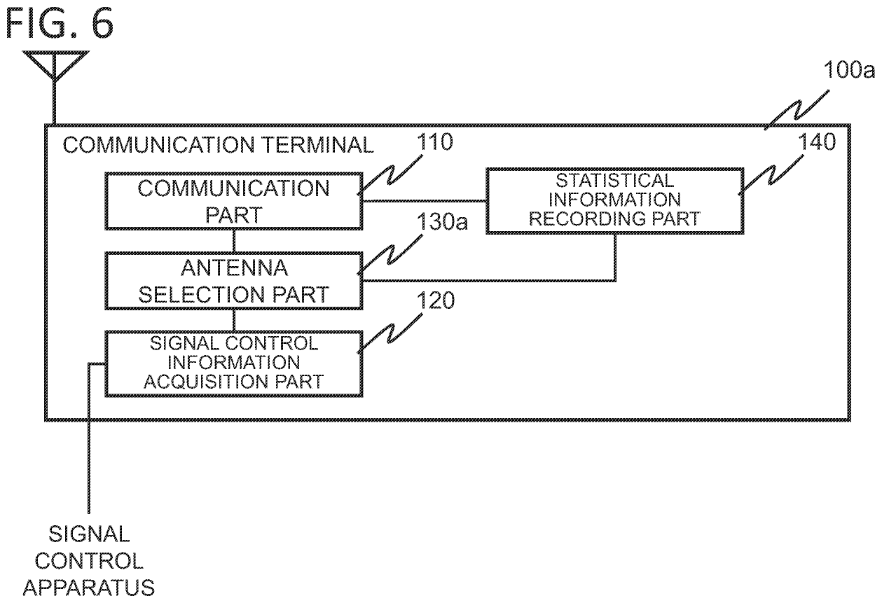

FIG. 6 is a function block diagram showing a configuration of a communication terminal 100a according to the second example embodiment of the present invention. The differences from the communication terminal 100 according to the first example embodiment shown in FIG. 4 are that a statistical information recording part 140 is added and an antenna selection part 130a selects an antenna on the basis of statistical information.

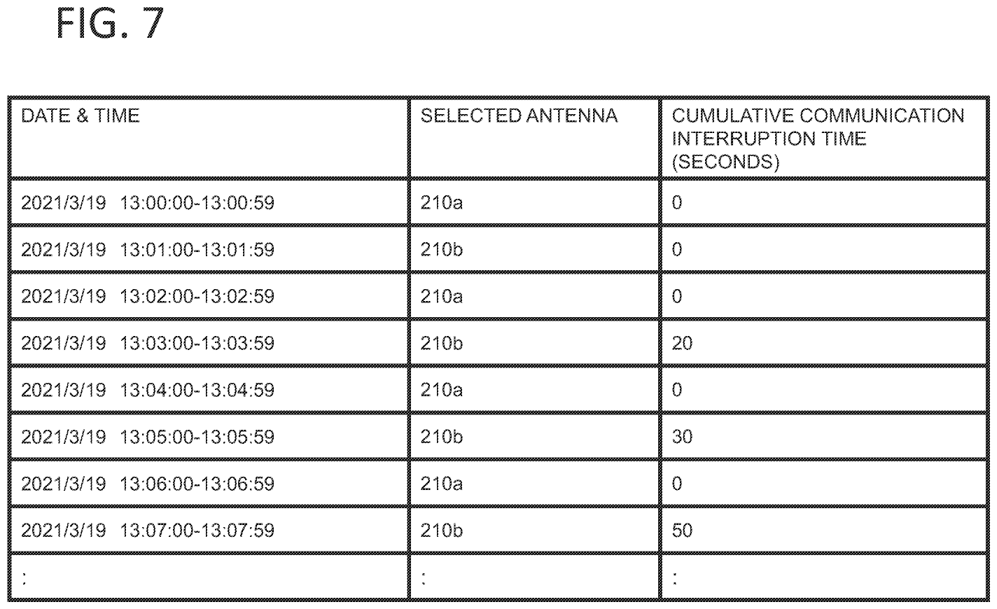

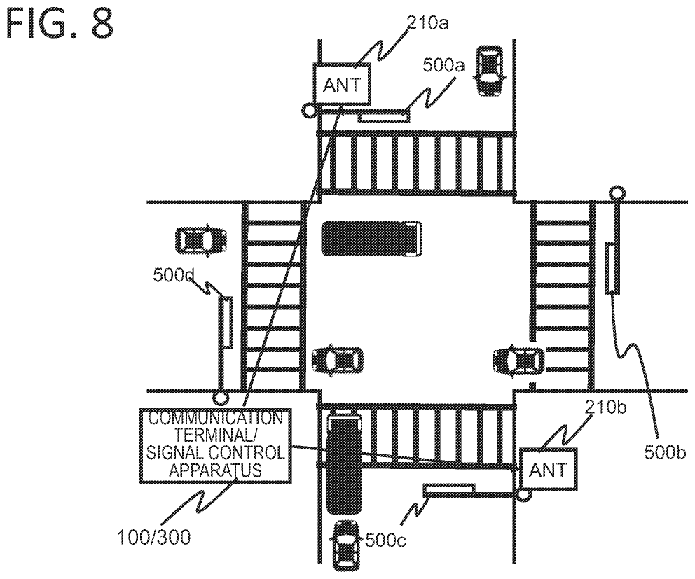

FIG. 7 is a drawing for describing an example of the statistical information recorded in the statistical information recording part 140. Here, the statistical information is statistical information about a communication of an antenna 210. For example, it includes a time (cumulative time) when a communication interruption has occurred, the number of momentary breakdowns, and so on. In the example shown in FIG. 7, the selected antenna and the time when the communication interruption occurred (cumulative time in the relevant time period) are recorded at regular intervals. For example, in the example shown in FIG. 7, it is recorded that after 13:03:00 on 3/19/2021, and when antenna 210b is selected, a communication interruption has occurred. There are various possible causes of this communication interruption. One of them may be that, as shown in FIG. 8, due to road congestion and/or an increase in the number of large vehicles, the cases, where large vehicles cross the stop line, stop between antenna 210b and communication terminal 100a and so on, are increased.

The antenna selection part 130a refers to the statistical information and selects an antenna on the basis of the statistical information instead of selecting an antenna on the basis of a signal control information, if the antenna selected on the basis of the signal control information is expected to deteriorate communication quality. For example, if the situation shown in FIG. 8 occurs, the antenna selection part 130a selects the antenna 210a instead of the antenna 210b. As for the statistical information referred to by the antenna selection part 130a, it may be a most recent statistical information as shown in FIG. 7, or it may be statistical information for the same time period in the past, or statistical information for the same day of the week, etc. The statistical information may be a value obtained by applying a statistical processing such as averaging to recorded values of the same time period in the past or recorded values of the same time period on the same day of the week, in addition to the most recent statistical information as shown in FIG. 7.

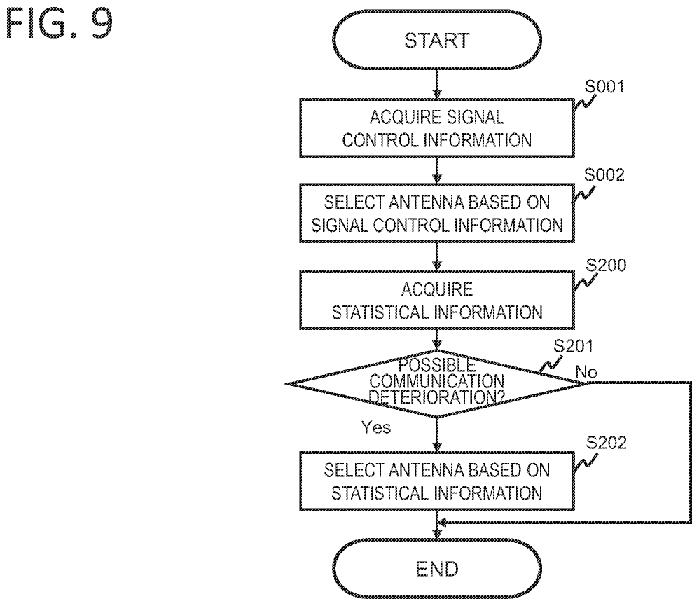

Next, an operation of the present example embodiment will be described in detail with reference to a drawing. FIG. 9 is a flowchart showing an operation of the communication terminal 100a according to the second example embodiment of the present invention. Since the operations of the steps S001 and S002 in FIG. 9 are the same as those in the first example embodiment, the description thereof will be omitted.

Next, the communication terminal 100a refers to the statistical information to check whether or not the communication quality is expected to deteriorate when the antenna, selected on the basis of the signal control information, is used (steps S200 and S201). For example, as shown in FIG. 7, if communication interruption occurs when the antenna 210b is selected on the basis of the most recent statistical information, the communication terminal 100a predicts that communication quality deterioration will occur at the antenna 210b. On the contrary, if communication interruption does not occur when the antenna 210a is selected on the basis of the most recent statistical information, communication terminal 100a predicts that communication quality deterioration will not occur at the antenna 210a.

If, as a result of the above checking, it is determined that there is no deterioration of communication quality at the antenna selected on the basis of the signal control information (No in step S201), the communication terminal 100a does not change the antenna selected in step S002.

On the other hand, if, as a result of the above checking, it is determined that there is a deterioration of communication quality at the antenna selected on the basis of the signal control information (Yes in step S201), the communication terminal 100a performs a selection of an antenna on the basis of the statistical information (step S202). For example, as shown in FIG. 7, if the communication quality is expected to be better when the antenna 210a is selected than when the antenna 210b is selected, the communication terminal 100a selects the antenna 210a. The change of antenna here is not mandatory. For example, if further deterioration of communication quality is expected when the antenna 210a is selected as a result of referring the statistical information, the antenna 210b may be selected.

According to the present example embodiment, which operates as described above, it is possible to select the optimal antenna based on the communication quality resulting from past antenna selection.

In the above embodiment, the statistical information recording part 140 is described as recording, at regular intervals, the selected antenna and the time at which the communication interruption occurred (cumulative time in the relevant time period), but statistical information is not limited to this example. For example, the number of times communication interruptions have occurred may be recorded as statistical information, and the degree of deterioration of communication quality may be determined on the basis of the number thereof. As for statistical information, the signal strength, signal-to-noise ratio, etc. observed when each antenna is selected may be measured and these values may then be used to determine the degree of degradation of communication quality.

### Third Example Embodiment

In the first and second example embodiments described above, the communication terminals 100 and 100a and the signal control apparatus 300 are described as being independently provided, but communication functions equivalent to the communication terminals 100 and 100a described above can be added to the signal control apparatus 300.

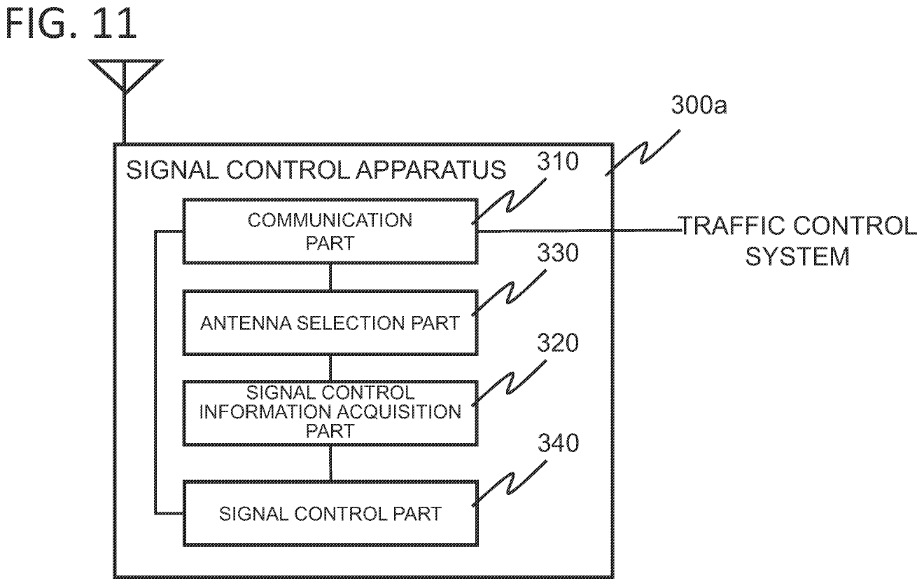

FIG. 11 is a function block diagram showing a configuration of a signal control apparatus 300a according to a third example embodiment of the present invention. With reference to FIG. 11, a configuration provided with a communication part 310, a signal control information acquisition part 320, an antenna selection part 330, and a signal control part 340 is shown.

The communication part 310, the signal control information acquisition part 320, and the antenna selection part 330 perform operations that correspond to those of the communication part 110, the signal control information acquisition part 120, and the antenna selection part 130, respectively, of the first example embodiment. Since the operations are basically the same as those in the first example embodiment, the description thereof will be omitted.

The signal control part 340 uses the communication part 310 to control the traffic signals 500a to 500d on the basis of control information received from the traffic control system. Therefore, the signal control part 340 functions as a signal control means that uses the communication part to control traffic signals on the basis of control information received from a predetermined traffic control system. The signal control part 340 provides the signal control information to the signal control information acquisition part 320.

Since the other configurations and operations are the same as those in the first example embodiment, the description thereof will be omitted. It goes without saying that it is possible to add a statistical information recording part to provide functions equivalent to those of the second example embodiment.

As described above, the present invention can also be realized as a function of the signal control apparatus 300a.

While each example embodiment of the present invention has been described, it is to be understood that the present invention is not limited to the example embodiments above and that further modifications, replacements, or adjustments can be made without departing from the basic technical concept of the present invention. For example, the apparatus configuration, the configuration of each element, and the expression of the data shown in each drawing are examples to facilitate understanding of the present invention and the present invention is not limited to the configurations shown in the drawings. For example, in each of the above example embodiments, a method is adopted that using signal control information to detect the traffic flow, however, the method for detecting the traffic flow is not limited thereto. If a camera that photographs a lighting state of a signal and/or a vehicle is installed near the traffic signal, the traffic flow may be detected by using an image obtained by the camera. For example, if a vehicle detector is installed near the traffic signal, the traffic flow may be detected by using sensor information obtained from the vehicle detector.

In each of the example embodiments above, a base station installed at a traffic signal is described as being a 5G base station, but in light of the principles of the present invention, a type of the base station is not limited to the 5G base station. For example, a LTE (Long Term Evolution) base station or a base station for 5th generation mobile communication system may be used. A Base station (roadside unit) for road-to-vehicle communication may also be used.

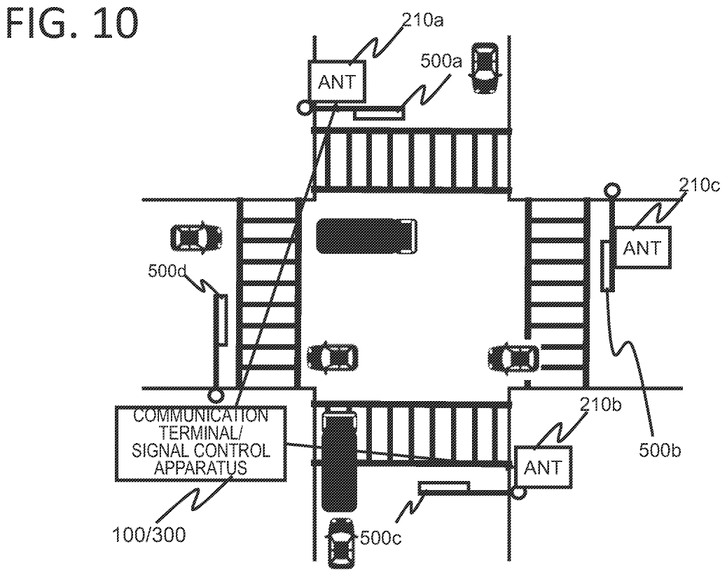

In each of the example embodiments described above, the antenna is described as being selected from two antennas, 210a and 210b, but the arrangement of antennas at the intersection is not limited to the example shown in FIG. 3. For example, as shown in FIG. 10, if a third antenna 210c installed at the traffic signal 500b is available, a configuration in which the third antenna 210c is selected can also be employed.

In each of the example embodiments described above, the antennas 210a and 210b are described as being installed on top of lights 500 of the traffic signals, but the arrangement of the antennas at individual traffic signals is not limited to the example shown in FIG. 2. For example, a configuration in which mounting tables for antennas 210a and 210b, and RUs 220a and 220b are installed directly above the signal poles of the individual traffic signals can also be presumed. In this case, the present invention can also be implemented without problems.

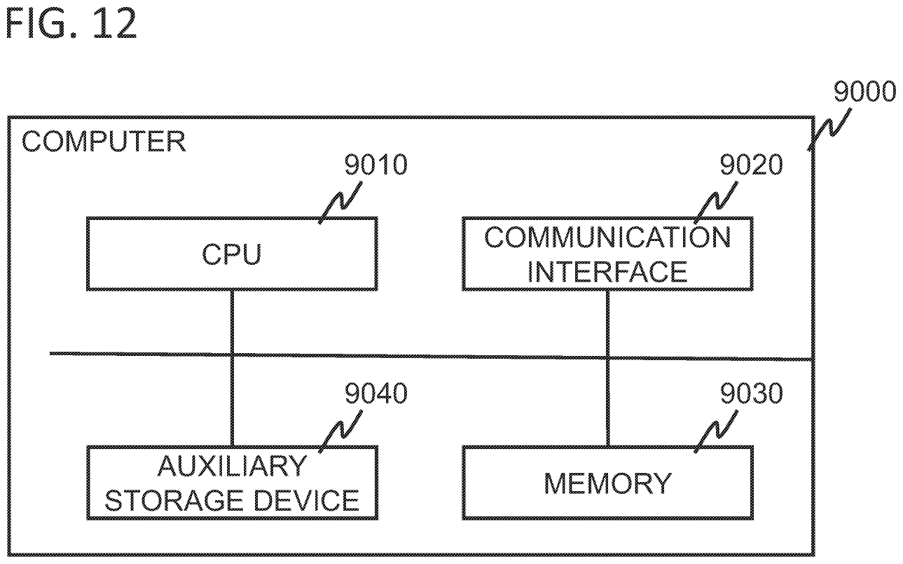

The procedures described in each example embodiment described above can be implemented by a program causing a computer (9000 in FIG. 12) that functions as the communication terminal or the signal control apparatus to realize the functions of these apparatuses. Such a computer is exemplified as a configuration provided with a central processing unit (CPU) 9010, a communication interface 9020, a memory 9030, and an auxiliary storage device 9040 as shown in FIG. 12. In other words, a traffic flow detection program and an antenna selection program may be executed by the CPU 9010 in FIG. 12.

In other words, each part (each processing means or function) of the communication terminal or the signal control apparatus described above can be realized by a computer program causing a processor installed in these apparatuses to execute each of the processes described above using the hardware thereof.

Finally, preferred modes of the present invention will be summarized. A part or the entire of the example embodiments disclosed above may be also described as the following modes, but not limited thereto.

### [Mode 1]

### (Refer to the Communication Terminal According to the First Aspect.)

### [Mode 2]

In the communication terminal described above, it can be configured that the traffic flow detection part detects the traffic flow on both the first road and the second road, and the selection part selects, from the first antenna and the second antenna, an antenna that is installed at a location across a road with a lower traffic flow of the road.

### [Mode 3]

In the communication terminal described above, it can be configured that the traffic flow detection part uses one of a lighting state of a traffic signal and signal control signal to detect the traffic flow, and the selection part selects, from the first antenna and the second antenna, an antenna of which a straight line connecting the communication terminal and the first antenna or the second antenna does not intersect with a lane where the lighting state is green to make a connection.

### [Mode 4]

In the communication terminal described above, it can be configured that the selection part refers to a statistical information showing a history of communication quality and selects an antenna on a basis of the statistical information instead of selecting an antenna depending on the traffic flow, if an antenna selection depending on the traffic flow is expected to deteriorate the communication quality.

### [Mode 5]

In the communication terminal described above, it can be configured that
the statistical information includes a cumulative time of communication interruptions during communication with the antenna being selected or a number of times of occurrence of the communication interruptions, and
a selection of an antenna is performed on a basis of the statistical information instead of selecting an antenna depending on the traffic flow, if at least one of the cumulative time of the communication interruptions during communication with the antenna being selected and the number of times of occurrence of the communication interruptions exceeds a predetermined criterion.

### [Mode 6]

In the communication terminal described above, it can be configured that the first antenna and the second antenna are directional antennas in a base station of a 5th generation mobile communication system that provides a service to a mobile body traveling on the road, and the communication terminal is connected to a traffic control system via the base station and performs communication for a traffic control with the traffic control system.

### [Mode 7]

### (Refer to the Signal Control Apparatus According to the Second Aspect.)

### [Mode 8]

### (Refer to the Communication Terminal Control Method According to the Third Aspect.)

### [Mode 9]

### (Refer to the Program According to the Fourth Aspect.)

The above modes 7 to 9 can be expanded in the same way as mode 1 is expanded to modes 2 to 6.

The disclosure of each Patent Literature and Non-Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the Claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the disclosure of the present invention. That is, it is self-explanatory that the present invention includes any types of variations and modifications to be done by a skilled person according to the whole disclosure including the Claims and the technical concept of the present invention. Particularly, any numerical ranges disclosed herein should be interpreted that any intermediate values or subranges falling within the disclosed ranges are also concretely disclosed even without specific recital thereof. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present application.

### REFERENCE SIGNS LIST

10: communication terminal
11: communication part
12: traffic flow detection part
13: selection part
20a, 20b: antenna
100, 100a: communication terminal
110, 310: communication part
120, 320: signal control information acquisition part
130, 130a, 330: antenna selection part
140: statistical information recording part
210a, 210b: antenna (ANT)
220a, 220b: radio unit (RUS)
230: distributed unit (DU)
240: central unit (CU)
250: 5G core network
300, 300a: signal control apparatus
340: signal control part
400: traffic control system
500: light
500a to 500d: traffic signal
600: signal pole
9000: computer
9010: CPU
9020: communication interface
9030: memory
9040: auxiliary storage device

What is claimed is:

1. A communication terminal, comprising:
at least a processor; and
a memory in circuit communication with the processor,
wherein the processor is configured to execute program instructions stored in the memory to implement:
a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road;
a traffic flow detection part for detecting a traffic flow on at least one of the first road and the second road; and
a selection part for selecting an antenna to be connected from the first antenna and the second antenna depending on the traffic flow.

2. The communication terminal according to claim 1, wherein
the traffic flow detection part detects the traffic flow on both the first road and the second road, and
the selection part selects, from the first antenna and the second antenna, an antenna that is installed at a location across a road with a lower traffic flow of the road.

3. The communication terminal according to claim 1, wherein
the traffic flow detection part uses one of a lighting state of a traffic signal and signal control signal to detect the traffic flow, and
the selection part selects, from the first antenna and the second antenna, an antenna of which a straight line connecting the communication terminal and the first antenna or the second antenna does not intersect with a lane where the lighting state is green to make a connection.

4. The communication terminal according to claim 1, wherein
the selection part refers to a statistical information showing a history of communication quality and selects an antenna on a basis of the statistical information instead of selecting an antenna depending on the traffic flow, if an antenna selection depending on the traffic flow is expected to deteriorate the communication quality.

5. The communication terminal according to claim 4, wherein
the statistical information includes a cumulative time of communication interruptions during communication with the antenna being selected or a number of times of occurrence of the communication interruptions, and
a selection of an antenna is performed on a basis of the statistical information instead of selecting an antenna depending on the traffic flow, if at least one of the cumulative time of the communication interruptions during communication with the antenna being selected and the number of times of occurrence of the communication interruptions exceeds a predetermined criterion.

6. The communication terminal according to claim 1, wherein
the first antenna and the second antenna are directional antennas in a base station of a 5th generation mobile communication system that provides a service to a mobile body traveling on the road, and
the communication terminal is connected to a traffic control system via the base station and performs communication for a traffic control with the traffic control system.

7. A signal control apparatus, comprising:
a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road;
a traffic flow detection part for detecting a traffic flow on at least one of the first road and the second road;
a selection part for selecting an antenna to be connected from the first antenna and the second antenna depending on the traffic flow; and
a signal control part for controlling a traffic signal on a basis of control information received from a certain traffic control system via the communication means part.

8. The signal control apparatus according to claim 7, wherein
the traffic flow detection part detects the traffic flow on both the first road and the second road, and
the selection part selects, from the first antenna and the second antenna, an antenna that is installed at a location across a road with a lower traffic flow of the road.

9. A control method for a communication terminal comprising a communication part for selecting one of a first antenna and a second antenna and for being capable of communicating via a wireless connection with a base station connected to the first antenna and the second antenna, the first antenna being installed at a first location across a first road, the second antenna being installed at a second location across a second road intersecting the first road, the control method comprising:
detecting a traffic flow on at least one of the first road and the second road; and
selecting an antenna to be connected from the first antenna and the second antenna depending on the traffic flow.

10. The control method according to claim 9, comprising:
detecting the traffic flow on both the first road and the second road, and
selecting, from the first antenna and the second antenna, an antenna that is installed at a location across a road with a lower traffic flow of the road.

11. (canceled)

12. The communication terminal according to claim 2, wherein
the traffic flow detection part uses one of a lighting state of a traffic signal and signal control information to detect the traffic flow, and
the selection part selects, from the first antenna and the second antenna, an antenna of which a straight line connecting the communication terminal and the first antenna or the second antenna does not intersect with a lane where the lighting state is green to make a connection.

13. The communication terminal according to claim 2, wherein
the selection part refers to a statistical information showing a history of communication quality and selects an antenna on a basis of the statistical information instead of selecting an antenna depending on the traffic flow, if an antenna selection depending on the traffic flow is expected to deteriorate the communication quality.

14. The communication terminal according to claim 3, wherein
the selection part refers to a statistical information showing a history of communication quality and selects an antenna on a basis of the statistical information instead of selecting an antenna depending on the traffic flow, if an antenna selection depending on the traffic flow is expected to deteriorate the communication quality.

15. The communication terminal according to claim 2, wherein
the first antenna and the second antenna are directional antennas in a base station of a 5th generation mobile communication system that provides a service to a mobile body traveling on the road, and
the communication terminal is connected to a traffic control system via the base station and performs communication for a traffic control with the traffic control system.

16. The communication terminal according to claim 3, wherein
the first antenna and the second antenna are directional antennas in a base station of a 5th generation mobile communication system that provides a service to a mobile body traveling on the road, and
the communication terminal is connected to a traffic control system via the base station and performs communication for a traffic control with the traffic control system.

17. The communication terminal according to claim 4, wherein
the first antenna and the second antenna are directional antennas in a base station of a 5th generation mobile communication system that provides a service to a mobile body traveling on the road, and
the communication terminal is connected to a traffic control system via the base station and performs communication for a traffic control with the traffic control system.

18. The communication terminal according to claim 5, wherein
the first antenna and the second antenna are directional antennas in a base station of a 5th generation mobile communication system that provides a service to a mobile body traveling on the road, and
the communication terminal is connected to a traffic control system via the base station and performs communication for a traffic control with the traffic control system.

19. The control method according to claim 9, wherein
the traffic flow is detected by using one of a lighting state of a traffic signal and signal control information, and
an antenna of which a straight line connecting the communication terminal and the first antenna or the second antenna does not intersect with a lane where the lighting state is green to make a connection is selected from the first antenna and the second antenna.

20. The control method according to claim 9, wherein
an antenna is selected on a basis of the statistical information instead of selecting an antenna depending on the traffic flow, if an antenna selection depending on the traffic flow is expected to deteriorate the communication quality, referring to a statistical information showing a history of communication quality.

21. The control method according to claim 20, wherein
the statistical information includes a cumulative time of communication interruptions during communication with the antenna being selected or a number of times of occurrence of the communication interruptions, and
an antenna is selected on a basis of the statistical information instead of selecting an antenna depending on the traffic flow, if at least one of the cumulative time of the communication interruptions during communication with the antenna being selected and the number of times of occurrence of the communication interruptions exceeds a predetermined criterion.
